(19) United States
(12) Patent Application Publication
(10) Pub. No.: US 2026/0258830 A1
(43) Pub. Date: Sep. 3, 2026

(54) CARABINER AND METHOD OF USE

(71) Applicant: ZEDEL, Crolles (FR)

(72) Inventors: Christophe QUILLARD, Eybens (FR); Olivier MATHÉ, Taninges (FR); Alain MAURICE, Le Plateau des Petites Roches (FR)

(73) Assignee: ZEDEL, Crolles (FR)

(21) Appl. No.: 19/554,881

(22) Filed: Mar. 3, 2026

(30) Foreign Application Priority Data
Mar. 3, 2025 (FR) 2502109

(51) Int. Cl. F16B 45/02

(52) U.S. Cl. CPC F16B 45/023; F16B 45/024; F16B 45/029

(57) ABSTRACT

A carabiner comprises a body having a first end and a second end and also a gate. The gate is installed pivotally movable with respect to the body, the gate being movable between an open position and a closed position. A latch presents a locked position and an unlocked position. In the unlocked position, the gate is free to move between the open position and the closed position. When the gate is in the closed position, moving the latch from the unlocked position to the locked position keeps the gate in the closed position. When the gate is in the open position, moving the latch from the unlocked position to the locked position keeps the gate in the open position.

### BACKGROUND OF THE INVENTION

The invention relates to a carabiner and to a method for using a carabiner.

### STATE OF THE ART

Different configurations of carabiners are known having a C-shaped body and a gate installed pivotally movable to define an open position and a closed position.

To prevent unintentional opening of the gate, several different configurations of locking systems exist that are configured to lock the gate in the closed position.

To lock the gate in the closed position, it is known to form a gate provided with a ferrule that screws along the gate. Screwing the ferrule tight by twisting the latter through several turns enables the gate to be firmly secured in the closed position. This configuration prevents the gate from moving to the closed position when the gate was initially in the open position. The applicant markets carabiners that are provided with such a locking system under the trade name “SCREW-LOCK”.

Locking systems also exist that are attached to the gate and have more complex movements to exit the closed position and allow movement of the gate to the open position. The applicant markets carabiners that are provided with such a locking system under the trade names “TRIACT-LOCK”, “BALL-LOCK”, “PIN-LOCK”, “TWIST-LOCK” or “WIRE-LOCK.

A bar is also known that is fastened on the one hand to the gate and on the other hand to the body to lock the gate in the closed position. The applicant markets carabiners that are provided with such a locking system under the “CAPTIV” trade name. One embodiment is presented in the document US 2016/0281766.

Other configurations of locking systems configured to lock the gate in the closed position are illustrated in the documents WO 2005/073571, GB 2481800, EP 2538095 and US 2005/0229367.

It is apparent that, with use, employing a locking system enabling the gate to be locked in the closed position does not provide satisfactory functioning, in particular as regards inserting an item of equipment in the carabiner. A large number of locking systems have a default locked position thereby making insertion of an item of equipment complicated to perform. Locking systems also exist that reduce the accessible volume inside the carabiner.

### SUMMARY OF THE INVENTION

One object of the invention consists in remedying these shortcomings, and more particularly in providing a carabiner that makes insertion of an item of equipment in the carabiner easier to perform while at the same time enabling the carabiner to be locked in the closed position.

These shortcomings tend to be overcome by means of a carabiner comprising:
a body having a first end and a second end;
a gate, the gate being installed pivotally movable with respect to the body, the gate being movable between an open position and a closed position;
a latch presenting a locked position and an unlocked position;
wherein, in the unlocked position, the gate is free to move between the open position and the closed position;
wherein, when the gate is in the closed position, moving the latch from the unlocked position to the locked position keeps the gate in the closed position.

The carabiner is remarkable in that when the gate is in the open position, moving the latch from the unlocked position to the locked position keeps the gate in the open position.

According to one feature of the invention, the latch is attached to the gate and follows the movement of the gate between the open position and the closed position.

In preferential manner, when the gate is in the open position, the latch in the locked position applies a force on the first end of the body.

In a particular embodiment, the latch is installed pivoting between the locked position and the unlocked position around an axis that connects a first end of the gate and a second end of the gate. The latch defines a hook that hooks onto the first end of the body when the gate is in the open position.

Advantageously, when the latch is in the locked position, the hook has an outer wall designed to press against an inner wall of the body to prevent movement of the gate from the closed position to the open position. An inner wall of the hook presses against the first end of the body to prevent movement of the gate from the open position to the closed position.

In a particular embodiment, the first end of the body defines a hole receiving the hook when the latch is in the locked position and the gate is in the open position.

Preferentially, the hook pivots through a first angle between the unlocked position and the locked position when the gate is in the closed position. The hook pivots through a second angle between the unlocked position and the locked position when the gate is in the closed position, the first angle being larger than the second angle.

In another development, the latch presents an unstable state between the locked position and the unlocked position, the latch having a spring biasing a ferrule and the gate to leave the unstable position and move to the locked position or the unlocked position.

Advantageously, the first end of the body forms a stop, the spring applying a force on the first end of the body when the gate is in the open position.

Preferentially, the first end of the body forms an end-of-travel stop configured to limit the opening angle of the gate in the open position, the end-of-travel stop being in contact with the gate or with the latch.

It is a further object of the invention to provide a method for using a carabiner that is efficient and enables functioning of the latter to be improved.

This result tends to be achieved by means of a method for using a carabiner comprising the following steps:
providing a carabiner according to any one of the foregoing configurations;
placing the latch in the locked position when the gate is in the open position to lock the gate in the open position:

### DESCRIPTION OF THE DRAWINGS

Other advantages and features will become more clearly apparent from the following description of particular embodiments and implementation modes of the invention given for non-restrictive example purposes only and represented in the appended drawings, in which:

FIG. 1: schematically illustrates a perspective view of a first embodiment of a carabiner with the gate in the closed position and the latch in the unlocked position;

FIG. 2: schematically illustrates a side view of the first embodiment of a carabiner with the gate in the closed position and the latch in the unlocked position;

FIG. 3: schematically illustrates a perspective view of a first embodiment of a carabiner with the gate in the closed position and the latch in the locked position;

FIG. 4: schematically illustrates a side view of the first embodiment of a carabiner with the gate in the closed position and the latch in the locked position;

FIG. 5: schematically illustrates a perspective view of the first embodiment of a carabiner with the gate in the open position and the latch in the unlocked position;

FIG. 6: schematically illustrates a perspective view of the first embodiment of a carabiner with the gate in the open position and the latch in the locked position;

FIG. 7: schematically illustrates a side view of the first embodiment of a carabiner with the gate in the open position and the latch in the locked position;

FIG. 8: schematically illustrates a sectional view of the carabiner with the gate in the closed position and the latch in the unlocked position along the cutting plane AA of FIG. 2;

FIG. 9: schematically illustrates a sectional view of the carabiner with the gate in the closed position and the latch in the locked position along the cutting plane AA of FIG. 4;

FIG. 10: schematically illustrates a bottom view of a ferrule of the locking system;

FIG. 11: schematically illustrates a longitudinal sectional view of the ferrule of the locking system;

FIG. 12: schematically illustrates a top view of the gate;

FIG. 13: schematically illustrates a longitudinal sectional view of the gate;

FIG. 14: schematically illustrates a view of a roping harness provided with a wire element designed to attach the carabiner.

### DETAILED DESCRIPTION

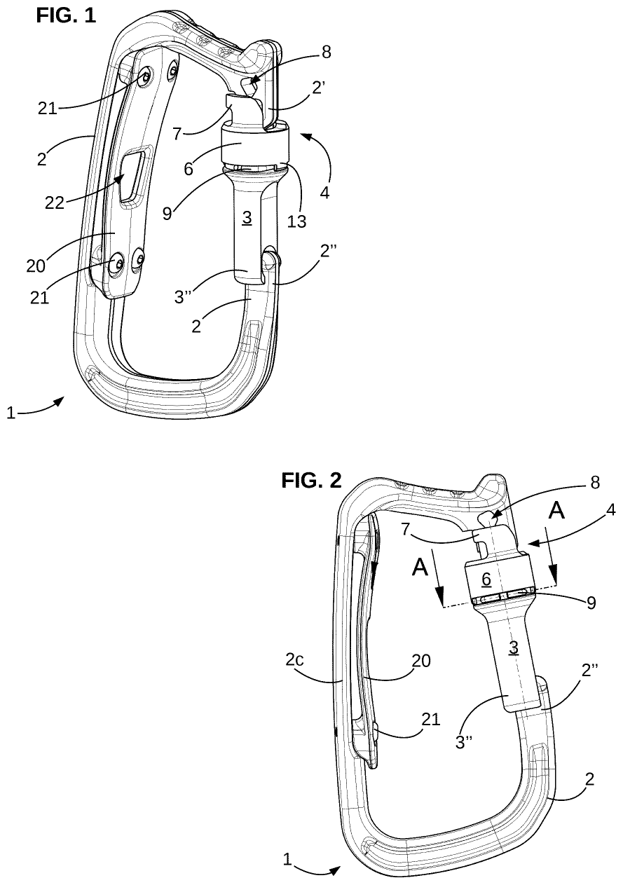

FIGS. 1 to 7 illustrate a carabiner 1 in the open position or in the closed position. The carabiner 1 has a body 2 and a gate 3. The body 2 is C-shaped or U-shaped and extends from a first end 2′ to a second end 2″. The body 2 defines an opening and the gate 3 is installed pivotally movable with respect to the body 2.

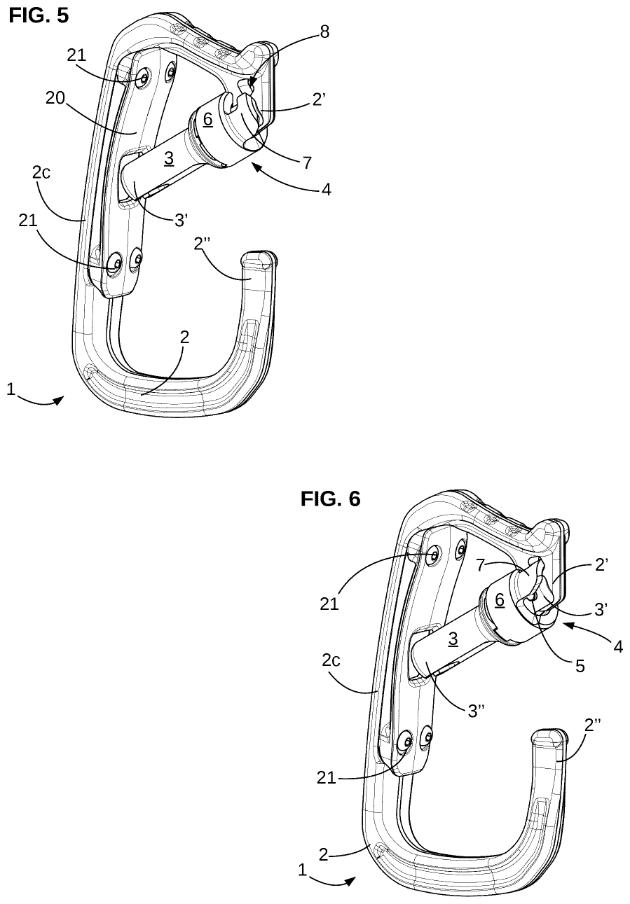

The gate 3 is installed able to move between an open position and a closed position to leave the opening open or closed. In the open position, the gate 3 allows a tool to be inserted in the body 2 or allows the tool to be extracted from the body 2. In the closed position, the gate 3 prevents insertion of a tool in the body 2 and prevents extraction of the tool from the body 2. FIGS. 1 to 4 illustrate the gate 3 in the closed position whereas FIGS. 5 to 7 illustrate the gate 3 in the open position. When movement of the gate 3 takes place from the closed position to the open position, a first end 3′ of the gate 3 moves towards a central portion 2c of the body 2. The central portion 2c connects the first end 2′ and the second end 2″.

The carabiner 1 has a latch 4 that is configured to secure the position of the gate 3 in a predefined position.

The gate 3 has a first end 3′ and a second end 3″ that are opposite ends in a longitudinal direction of the gate 3. The first end 2′ of the body 2 is attached to the first end 3′ of the gate 3 by means of a pivot shaft 5. The gate 3 pivots around the pivot shaft 5.

The latch 4 presents a locked position and an unlocked position. In the locked position, the latch 4 freezes the position of the gate 3. When the gate 3 is in the open position and the latch 4 switches from the unlocked position to the locked position, the latch 4 keeps the gate 3 in the open position. When the gate 3 is in the closed position and the latch 4 switches from the unlocked position to the locked position, the latch 4 keeps the gate 3 in the closed position. In preferential manner, the latch 4 is configured to lock the gate 3 in a limited number of positions, for example in one of the two possible positions.

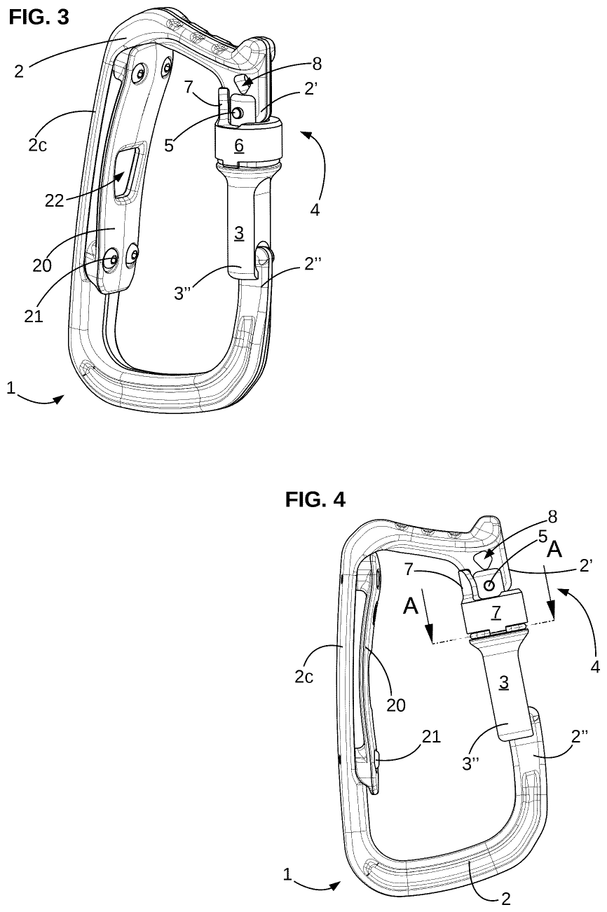

When the latch 4 is in the unlocked position, the gate 3 can be moved freely between the open position and the closed position. When the latch 4 is in the locked position, the latch 4 is able to secure the gate 3 in the open position or in the closed position. FIGS. 1, 2 and 5 illustrate the latch 4 in the unlocked position. FIGS. 3, 4, 6 and 7 illustrate the latch 4 in the locked position.

Securing the gate 3 in the closed position prevents any unintentional opening, i.e. ensures that the tool or tools remain in the body 2 of the carabiner 1. Securing the gate 3 in the open position makes it easier to hook a tool onto the body 2 and to extract the tool from the body 2.

The latch 4 in the locked position enables the gate 3 to be kept in the open position or in the closed position thereby making the carabiner easier to use according to requirements. In an alternative embodiment, the latch 4 is only configured to lock the gate 3 in the open position.

It is particularly advantageous for the same part of the latch 4 to operate to define the locked position that locks the gate 3 when the gate 3 is in the open position and when the gate 3 is in the closed position.

To have a compact the latch 4, it is advantageous for the latch 4 to be installed on the gate 3. In the unlocked position, the latch 4 moves with the gate 3 when the gate 3 moves between the open position and the closed position.

In advantageous manner, the latch 4 is installed pivoting around the axis that connects the first end 3′ and the second end 3″. Pivotal installation makes it easier to lock the gate 3 in the open position or in the closed position when the gate 3 is respectively placed in the open or closed position.

It is particularly advantageous for the latch 4 to act mechanically on the first end 2′ of the body 2 to keep the gate 3 in a predefined position when the latch 4 is in the locked position. In a prior art configuration, the latch 4 acts on second end of gate 2. Such a configuration makes locking in the open position more difficult.

The forces applied on the gate 3 are different depending on whether the gate 3 is locked in the closed position or locked in the open position. It is advantageous to provide a latch 4 that withstands the applied forces well while remaining compact and easy to use. It was observed that it is advantageous to provide for the latch 4 to be tensile stressed when the gate 3 is locked in the closed position and it is sought to move the gate 3 to the open position. It is also advantageous for the latch 4 to be compressive stressed when the gate 3 is locked in the open position and it is sought to move the gate 3 to the closed position.

It is particularly advantageous for the latch 4 to be located in the first end 3′ of the gate 3 as this part of the gate 3 is less stressed when tools are inserted in the carabiner 1 or extracted from the carabiner 1. This prevents undesired activation of the latch 4. It is preferable for the second end 3″ of the gate 3 to be devoid of the latch 4. This also enables the opening angle of the gate 3 not to be reduced.

To form a latch 4 that is compact and that does not reduce the opening angle of the gate 3, it is advantageous for the latch 4 to be equipped with a ferrule 6 that is installed pivoting around the gate 3. The ferrule 6 is installed in the first end 3′ of the gate 3.

In a preferential embodiment, the latch 4 has a hook 7. The hook 7 is installed salient from the ferrule 6.

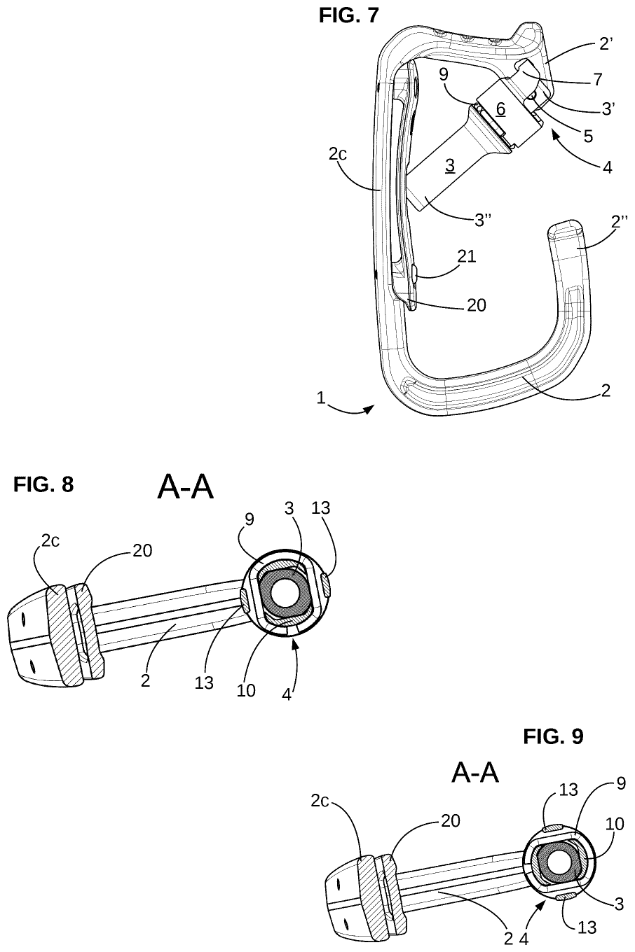

In the locked position, the hook 7 of the latch 4 can be inserted in a hole of the body 2 to keep the gate 3 in the selected position. For example as illustrated in FIGS. 6 and 7, when the gate 3 is in the open position and the latch 4 is in the closed position, the hook 7 is inserted in a hole 8 arranged in the body 2. The hook 7 installed in the hole 8 keeps the gate 3 securely in the open position. A force attempting to move the gate 3 to the closed position results in application of a tensile stress on the hook 7.

In the illustrated embodiment, the body 2 defines a single hole 8 arranged to collaborate with the hook 7 and secure the gate 3 in the open position. In an alternative embodiment that is not illustrated, the body 2 defines two holes. One of the holes enables the gate 3 to be kept in the open position whereas the other of the holes enables the gate 3 to be kept in the closed position.

It is particularly advantageous to provide for the hook 7 to pivot around the gate 3 and preferentially around the longitudinal axis of the gate 3 so as to move between the locked position and the unlocked position.

In a particular embodiment, the hook 7 has an outer wall designed to press against an inner wall of the body 2 to prevent movement of the gate 3 from the closed position to the open position. An inner wall of the hook 7 presses against the first end of the body 2 to prevent the gate 3 from moving from the open position to the closed position.

For ease of actuation of the latch 4 and in particular actuation of the latter with one hand, it is advantageous for shifting between the locked position and the unlocked position to correspond to pivoting of the ferrule 6 through an angle of less than 360°. It is particularly advantageous for movement from the locked position to the unlocked position of the latch 4 to take place in the same direction regardless of the position of the gate 3. It is also advantageous for movement from the unlocked position to the locked position of the latch 4 to take place in the same direction regardless of the position of the gate 3. It is furthermore advantageous for movement from the unlocked position to the locked position of the latch 4 to take place in an opposite direction to movement from the locked position to the unlocked position. This enables the user to know quickly and surely how the carabiner is configured without having to look at the carabiner.

Preferentially, the hook 7 pivots through a first angle between the unlocked position and the locked position when the gate 3 is in the closed position. The hook 7 pivots through a second angle between the unlocked position and the locked position when the gate 3 is in the closed position. The first angle is larger than the second angle. In other words, when the hook 7 moves from the unlocked position to the locked position, the hook 7 pivots through a smaller angle when the gate 3 is in the open position in comparison with pivoting when the gate 3 is in the closed position.

In a preferential configuration, when the gate 3 is in the closed position, an outer wall of the hook 7 comes to face an inner wall of the body 2. The outer wall of the hook 7 presses on the inner wall of the body 2 thereby preventing the gate 3 from pivoting from the closed position to the open position. In the illustrated embodiment, the inner wall of the body 2 defines a wall and the outer wall of the hook 7 presses against this wall to prevent the gate 3 from departing from the closed position. When the gate 3 is locked in the closed position, a force applied on the gate 3 to open the gate 3 results in a compressive force. The fact that the hook 7 is depressed more deeply into the thickness of the body 2 enables larger stresses to be withstood without stressing the end of the hook 7 too greatly.

When the hook 7 moves from the unlocked position to the locked position, it is advantageous to provide for the body 2 to form a stop when the gate 3 is in the closed position. The stop prevents movement of the hook 7 over a shorter distance when the gate 3 is in the open position in comparison with the gate 3 in the closed position.

On account of the fact that the hook 7 is more deeply depressed into the thickness of the body 2, a larger quantity of material is involved in keeping the gate 3 in the closed position.

When the gate 3 is in the closed position and when the latch 4 is in the locked position, the latch 4 is devoid of any pressing on the central portion 2c of the body 2. Numerous configurations are known from the prior art where the latch 4 has a swivelling arm that presses on the body to keep the gate 3 in the closed position. This configuration is not attractive as a part of the inner space of the carabiner is not accessible. Furthermore, the arm is not able to keep the gate 3 in the open position and forms a snag when it extends outside the plane of the carabiner.

It is advantageous for the gate 3 locked in the open position to have a second end 3″ that is in contact with or very close to a wall of the body 2, for example close to a central wall 2c of the body 2 to limit the risks of a tool catching on the gate 3 when the tool is removed from inside the carabiner 1. This prevents the hook 7 from being deformed by forcing the gate 3 open, which could prevent the hook 7 from being used to lock the gate 3 in the open position.

It is advantageous for the hole 8 formed in the body 2 and designed to receive the hook 7 to define a functional clearance with the hook 7. The functional clearance allows a slight movement of the gate 3. This enables the hook 7 not to be too greatly stressed when a tool is inserted in the carabiner 1 and the tool or the user's hand places a load on the gate 3. It is even more advantageous for the functional clearance between the hole 8 and the hook 7 to allow the gate 3 to abut against a central wall 2c of the body 2 so that the hook 7 is only biased to prevent closing of the gate 3 and not to prevent opening of the gate 3 beyond a threshold position. In an alternative embodiment, another part of the latch 4 can press against the body 2 to define the maximum opening of the gate 3 when the hook 7 is inserted in the hole 8.

FIGS. 6 and 7 illustrate the second end 3″ of the gate 3 that is pressing against central part 2c of the body 2 or is close to central part 2c when the gate 3 is in its maximum opening position and illustrate the ferrule 6 that is pressing against the wall of the first end 2′ of the body 2 in the maximum opening position. In the maximum opening position, the hook 7 is separated from side walls of the hole 8 by a functional clearance.

In an embodiment that is not illustrated, the latch 4 extends over the whole length of the gate 3. When the gate 3 is in the closed position, the second end 2″ of the body 2 is located in an opening arranged in the second end 3″ of the gate 3. When the latch 4 is in the locked position, the latch 4 keeps the second end 2″ of the body 2 firmly in the opening arranged in the second end 3″ of the gate 3. For example, the latch 4 rotates around the gate 3 to install a shutter that prevents the second end of the body 2 from departing. The shutter is arranged at the first end 3′ of the gate 3.

Advantageously, the latch 4 only has two stable positions that correspond to the locked position and to the unlocked position. The latch 4 has an unstable position between the locked position and the unlocked position that tends to move the latch 4 to the locked position or to the unlocked position. In the illustrated embodiment, the ferrule 6 has a first stable position corresponding to the ferrule 6 in the unlocked position and a second stable position corresponding to the ferrule 6 in the locked position. Between the two stable positions, the ferrule 6 is in an unstable position and tends to move to one of the two stable positions. This configuration makes it possible to choose whether the latch 4 is secured in the locked position or secured in the unlocked position.

It is particularly advantageous for the latch 4 to have a spring 9 that presses on the ferrule 6 of the latch 4 and that presses on the gate 3 or a head 10 arranged around the gate 3. The head 10 is installed between the spring 9 and the gate 3. In the embodiment illustrated in FIGS. 8, 9 and 10, the carabiner 1 has a gate 3 and the head 10 rotates around the gate 3. The head 10 is preferentially a part that is deformable in a direction perpendicular to the pivot axis. The shape of the gate 3 and the shape of the head 10 in association with the spring 9 define a stable position for the locked position and a stable position for the unlocked position. In the particular embodiment illustrated, the gate 3 presents several flat spots, for example at least two flat spots that define the two stable positions. The head 10 is fixedly secured with the ferrule 6 to rotate around the gate 3 with the ferrule 6 while enabling deformation of the head 10 with respect to the gate 3 and with respect to the ferrule 6. The head 10 enables the shape of the spring 9 and the shape of the gate 3 to be adjusted. It is advantageous for the head 10 to have at least one slot 11 to facilitate deformation of the head 10 perpendicularly to the pivot axis of the ferrule 6 around the gate 3. The ferrule 6 preferentially defines an imprint 12 that is non-circular and the spring 9 presses on the imprint 12.

In one embodiment, the spring 9 is distinct from the ferrule 6 and distinct from the gate 3. The spring 9 applies a force on the head 10 to better control deformation of the head 10. In another configuration, the ferrule 6 is elastically deformable and acts as a spring.

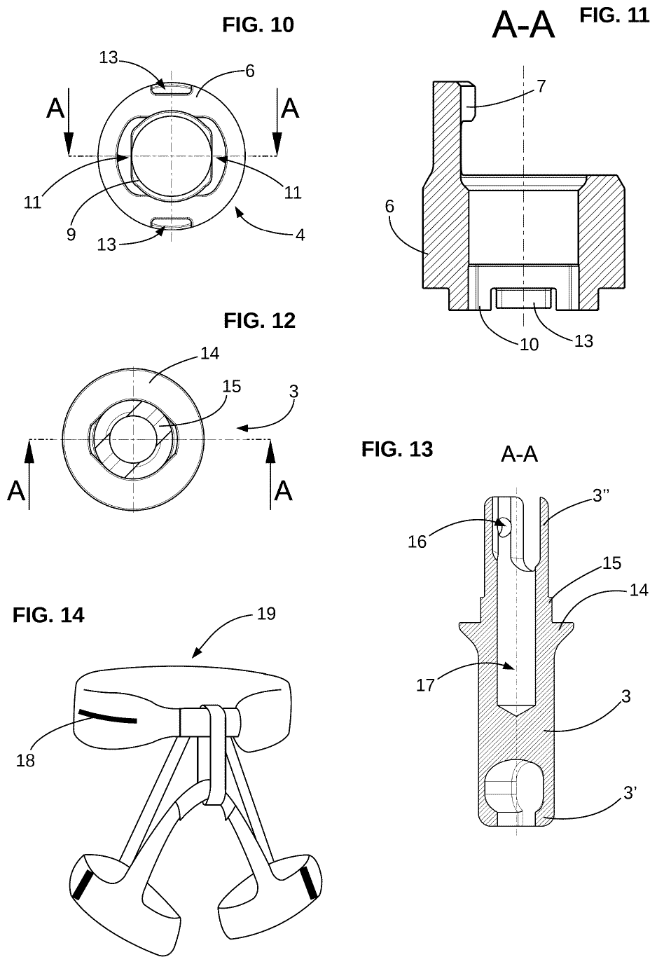

FIG. 10 illustrates a bottom view of the ferrule 6 that is provided with one or more tabs 13. The tabs 13 pivot around the gate 3 to keep the spring 9 in position around the gate 3. Advantageously, the head 10 is installed immovable with respect to the tabs 13. The ferrule 6 is hollow to let the gate 3 pass. The tabs 13 form skids that slide on the gate 3 to avoid placing a too great compressive stress on the spring 9 between the gate 3 and the ferrule 6 along the longitudinal axis of the gate 3.

FIG. 11 illustrates a longitudinal sectional view of the ferrule 6 that possesses the hook 7. The ferrule 6 can be a single-piece part. The ferrule 6 can define a tab 13 that is designed to anchor into the head 10 to drive the head 10 in rotation around the gate 3 when the ferrule 6 rotates around the gate 3. The ferrule 6 is a hollow component that is passed through by the gate 3 and that receives the head 10 between the gate 3 and the ferrule 6. The head 10 can form a single piece with the ferrule 6.

FIG. 12 illustrates a top view of a particular embodiment of the gate 3. In its first end 3′, the gate 3 advantageously defines a plate 14 designed to receive the spring 9, the head 10 and the ferrule 6. The gate 3 defines a salient area 15, in protrusion from the plate 14, that presents a non-circular section and preferably a section with one or more flat spots, preferentially several flat spots that enable the stable positions of the latch 4 to be defined.

It is advantageous for the gate 3 to define an opening 16 designed to receive the pivot shaft 5 to perform pivoting of the gate 3, but other configurations are possible.

It is advantageous for the gate 3 to be hollow in its first end 3′, the hollow area being able to receive a spring-loaded part that presses on the body 2 to bias the gate 3 to the closed position. The opening 17 in the first end 3′ of the gate 3 to receive a spring-loaded part is a conventional engineering feature.

As the carabiner 1 has a position where the gate 3 is locked in the open position, it is advantageous for the carabiner 1 to be made from metal, for example an aluminium or steel alloy, in order to withstand the applied stresses better.

To form a latch 4 that is compact, easy to use and cost-effective, it is advantageous for the latch 4 to be deprived of or to prevent translational movement in the longitudinal direction of the gate 3. For example the pivot shaft 5 and/or the shape of the first end 2′ can prevent translation.

Locking and unlocking of the gate 3 can only be performed with a pivoting movement. As an alternative, the latch 4 can impose a more complex movement with respect to the gate 3 to move from the unlocked position to the locked position and/or to move from the locked position to the unlocked position.

To form a latch 4 that is easy to use with one hand, it is advantageous for shifting between the locked position and the unlocked position not to require more than one full rotation of the latch 4, more preferentially not more than a half-turn of the latch 4 and even more preferentially a movement over less than 120° or even a quarter-turn, i.e. 90°.

In the illustrated embodiment, the latch 4 allows switching from the unlocked position to the locked position only when the gate 3 is in one of the two authorised positions. In the other positions of the gate 3, the latch 4 prevents the locked position from being reached.

In the illustrated configuration, the body 2 defines a single hole 8 designed to receive the hook 7 and an inner wall of the body 2 forms a wall designed to lock the gate 3 in the closed position when the gate 3 is in the locked position. The body 2 can be devoid of any other hole arranged along the path taken by the hook 7 between the hole 8 and the wall to prevent the latch 4 from locking the gate 3 elsewhere than in one of the two authorised positions.

It is particularly advantageous to have a curved hook 7 to follow the curvature of the outer wall of the gate 3 and to have a hook 7 that is close to the outer wall of the gate 3. The existence of a hook 7 increases the risk of seeing the hook 7 catch unintentionally on an outside element. Pivoting of the hook 7 in immediate proximity to the gate 3 makes unintentional catching of the latter more difficult. Furthermore, when the locked position of the hook 7 corresponds to the hook 7 arranged inside the internal volume of the carabiner 1, the risk of unintentional catching is low.

In an advantageous configuration illustrated in FIGS. 1 to 9, the carabiner 1 is provided with a blocking means of a wire element 18, preferably a webbing strap. The blocking means and the body 2 together define a slot designed for the wire element 18 or a ring to pass through performing securing of the wire element 18 and preferably jamming of the wire element 18. The blocking means enables the carabiner 1 to be attached to a wire element 18, for example a strap of a roping harness 19, thereby securing the carabiner 1 to a reference part, for example the roping harness 19. This configuration is particularly advantageous when the carabiner 1 is locked with the gate 3 in the open position. The blocking means enables the carabiner 1 to be fixedly secured regardless of the state of the gate 3.

In a preferential embodiment, the blocking means has a rod 20 arranged inside the volume bounded by the body 2 and the gate 3. This configuration is advantageous as the wire element 18 is located inside the carabiner 1 and cannot egress when the gate 3 is in the closed position.

The rod 20 can be fixed to the body 2 at one end thereby enabling the rod 20 to be transformed into a movable tab defining a slot. It is advantageous for the slot to extend beyond the second end of the gate 3 when the gate 3 is in the maximum opening position. In other words, the slot extends above the second end of the gate 3, the first end 2′ of the body 2 being located above the second end 2″ of the body 2. In the event of malfunctioning of the blocking means, the wire element 18 is located inside the ring bounded by the body 2 and the gate 3.

The blocking means can be formed by a rod 20 that is attached to the body 2. The rod 20 can be attached at one end or at its two opposite ends. The wire element 18 is installed between the body 2 and the rod 20, and the rod 20 is attached fixedly to the body 2 at its two opposite ends to prevent any separation. In another embodiment, a top end of the tab is attached to the body 2 and the rod 20 is elastically bendable. In a rest position, the bottom end is pressing against the body 2 to close the slot. The bottom end can be separated from the body 2 to open the slot and enable insertion or extraction of the wire element 18. The rod 20 can be secured to the body 2 by screws 21 or any other suitable fixing means.

When the rod 20 is attached at one of its ends only, it forms a deformable tab that allows a wire element 18 to be inserted and extracted. When the rod 20 is attached to the body 2 at both ends, the rod 20 and the body 2 define a closed ring that keeps the wire element 18 attached to the carabiner 1.

In advantageous manner, when the gate 3 is locked in the open position, the gate 3 forms an obstacle to movement of the rod 20 from a closed position securing the wire element 18 between the body 2 and the rod 20 to an open position enabling the wire element 18 to be extracted. As an alternative or as a complement, the rod 20 can define an aperture 22 that enables the gate 3 to be depressed into the rod 20. In the open position, the gate 3 can be in contact with the wire element 18 thereby making extraction of the latter from blocking means complicated.

Installation of the second end 3″ of the gate 3 in the aperture 22 enables movements of the second end 3″ to be blocked in directions perpendicular to the pivoting plane, i.e. the plane that receives pivoting of the gate 3. This enables the stresses applied on the pivot shaft 5 when the gate 3 is locked in the open position to be reduced.

Installation of the rod 20 in the inner volume of the carabiner 1 is particularly advantageous due to the fact that, in case of incorrect handling resulting in wire element 18 departing from blocking means, the wire element 18 can remain inside the carabiner 1. Wire element 18 and the carabiner 1 remain attached to one another.

In the closed position, the spring-loaded part biases the gate 3 so that the second end 3″ is in contact with the second end 2″ of the body 2 and closes the ring defined by the carabiner 1. The position of the gate 3 with respect to the body 2 is defined and the same is the case for the position of the latch 4 with respect to the body 2. It is then possible to actuate the latch 4 to the locked position and move to reach the locked position.

In the open position, the user acts on the gate 3 and compensates the action of the spring-loaded part. The position of the gate 3 is less well defined. It is advantageous for the first end 2′ of the body 2 to form an end-of-travel stop for opening of the gate 3. The first end 3′ of the gate 3 or the latch 4 are pressing on the part of the body 2 that forms the end-of-travel stop to prevent the second end 3″ of the gate 3 from being in contact with the body 2. This makes use of the rod 20 easier, in particular installation of the wire element 18. Once the end-of-travel stop has been reached, the user knows that he can move the latch 4 from the unlocked position to the locked position and reach the hole 8 or any other means enabling the gate 3 to be locked.

1. Carabiner comprising:
a body having a first end and a second end;
a gate, the gate being installed pivotally movable with respect to the body, the gate being movable between an open position and a closed position;
a latch presenting a locked position and an unlocked position;
wherein, in the unlocked position, the gate is free to move between the open position and the closed position;
wherein, when the gate is in the closed position, shifting of the latch from the unlocked position to the locked position keeps the gate in the closed position;
wherein when the gate is in the open position, shifting of the latch from the unlocked position to the locked position keeps the gate in the open position.

2. Carabiner according to claim 1 wherein the latch is attached to the gate and follows the movement of the gate between the open position and the closed position.

3. Carabiner according to claim 1 wherein, when the gate is in the open position, the latch in the locked position applies a force on the first end of the body.

4. Carabiner according to claim 2 wherein the latch is installed pivoting between the locked position and the unlocked position around an axis that connects a first end of the gate and a second end of the gate and wherein the latch defines a hook that hooks onto the first end of the body when the gate is in the open position.

5. Carabiner according to claim 4 wherein, when the latch is in the locked position, the hook has an outer wall designed to press against an inner wall of the body to prevent movement of the gate from the closed position to the open position and wherein an inner wall of the hook presses against the first end of the body to prevent movement of the gate from the open position to the closed position.

6. Carabiner according to claim 4 wherein the first end of the body defines a hole receiving the hook when the latch is in the locked position and when the gate is in the open position.

7. Carabiner according to claim 4 wherein the hook pivots through a first angle between the unlocked position and the locked position when the gate is in the closed position and wherein the hook pivots through a second angle between the unlocked position and the locked position when the gate is in the closed position, the first angle being larger than the second angle.

8. Carabiner according to claim 1 wherein the latch presents an unstable state between the locked position and the unlocked position, the latch having a spring biasing a ferrule and the gate to leave the unstable position and move to the locked position or the unlocked position.

9. Carabiner according to claim 8, wherein the latch is installed pivoting between the locked position and the unlocked position around an axis that connects a first end of the gate and a second end of the gate and wherein the latch defines a hook that hooks onto the first end of the body when the gate is in the open position, wherein the hook pivots through a first angle between the unlocked position and the locked position when the gate is in the closed position and wherein the hook pivots through a second angle between the unlocked position and the locked position when the gate is in the closed position, the first angle being larger than the second angle, wherein the first end of the body forms a stop, the spring applying a force on the first end of the body when the gate is in the open position.

10. Carabiner according to claim 1 wherein the first end of the body forms an end-of-travel stop configured to limit the opening angle of the gate in the open position, the end-of-travel stop being in contact with the gate or with the latch.

11. Method for using a carabiner comprising the following steps:
providing a carabiner according to claim 1;
placing the latch in the locked position when the gate is in the open position to lock the gate in the open position.
